(19) United States
(12) Patent Application Publication
(10) Pub. No.: US 2018/0313374 A1
(43) Pub. Date: Nov. 1, 2018

(54) ELECTRIC CLAMPING BRACKET AND CONTROL SYSTEM THEREOF

(71) Applicant: SHENZHEN BESTART TECHNOLOGY CO., LTD, Shenzhen (CN)

(72) Inventor: Guohui Zeng, Shenzhen (CN)

(21) Appl. No.: 16/030,879

(22) Filed: Jul. 10, 2018

Related U.S. Application Data
(63) Continuation-in-part of application No. PCT/CN2017/109267, filed on Nov. 3, 2017.

(30) Foreign Application Priority Data
Mar. 7, 2017 (CN) 201720214628.0

(51) Int. Cl. F16B 2/12; F16M 13/02; G05B 19/402

(52) U.S. Cl. CPC F16B 2/12; G05B 2219/49135; G05B 19/402; F16M 13/02

(57) ABSTRACT

An electric clamping bracket includes: a housing and a clamp assembly. The electric clamping bracket further includes a drive motor; the clamp assembly includes a left clamping frame and a right clamping frame; the left clamping frame and the right clamping frame extend forward and are respectively disposed on two opposite sides of the housing; the left clamping frame or/and the right clamping frame are slidably connected to the housing; and the drive motor drives the left clamping frame and/or right clamping frame so that the left clamping frame and the right clamping frame are close to each other or far apart opposite to each other. A control system of the electric clamping bracket is also disclosed. The electric clamping bracket uses the motor to drive the clamp assembly to clamp or release a mobile device, thus achieving automatic clamping or releasing of the clamping bracket.

### CROSS REFERENCE TO RELATED APPLICATIONS

The present application is a Continuation-In-Part application of PCT Application No. PCT/CN2017/109267 filed on Nov. 3, 2017, which claims the benefit of Chinese Patent Application No. 201720214628.0 filed on Mar. 7, 2017. All the above are hereby incorporated by reference.

### FIELD OF TECHNOLOGY

The present application relates to a clamping bracket and a control system thereof.

### BACKGROUND TECHNOLOGY

At present, the existing mobile phone and computer clamping brackets on the market either adopt the manner of spring-driven clamping components for clamping or screws for locking. When clamping, workers need to manually open the clamping components or manually lock, and unable to achieve intelligent locking.

### SUMMARY OF THE APPLICATION

In order to overcome the deficiencies of the above prior art, an objective of the present application is to provide an electric clamping bracket and a control system thereof.

The technical solution of the present application is:

An electric clamping bracket includes: a housing and a clamp assembly. The electric clamping bracket further includes a drive motor; the clamp assembly includes a left clamping frame and a right clamping frame; the left clamping frame and the right clamping frame extend forward and are respectively disposed on two opposite sides of the housing; the left clamping frame or/and the right clamping frame are slidably connected to the housing; and the drive motor drives the left clamping frame and/or right clamping frame so that the left clamping frame and the right clamping frame are close to each other or far apart opposite to each other.

A further technical solution is: the left clamping frame and the right clamping frame are respectively provided with a horizontally disposed left rack and a horizontally disposed right rack; an output end of the drive motor is provided with a gear that is drivenly connected between the left rack and the right rack; and the drive motor drives the left clamping frame and the right clamping frame to synchronously move towards or away from each other; or, the electric clamping bracket further includes a horizontally disposed left rack and a horizontally disposed right rack; the left rack and the right rack are respectively slidably connected to the housing; an output end of the drive motor is provided with a gear that is drivenly connected between the left rack and the right rack; the electric clamping bracket further includes a left elastic member and a right elastic member; a front end of the left elastic member presses against one end of the left clamping frame near the left rack, and a rear end of the left elastic member presses against the rear case; a front end of the right elastic member presses against one end of the right clamping frame near the right rack, and a rear end of the right elastic member presses against the rear case; when the drive motor forwardly drives the left rack and the right rack to move outward, the left rack and the right rack respectively press against inner ends of the left clamping frame and the right clamping frame so to synchronously move the left clamping frame and the right clamping frame outward and apart; and when the drive motor reversely drives the left rack and the right rack to move outward, the left clamping frame and the right clamping frame under a respective action of an elastic tension of the left elastic member and the right elastic member move inward and close together.

A further technical solution is: the housing includes a front cover and a rear case; and both sides of the rear case are respectively provided with a left mounting slot and a right mounting slot for passing through the left clamping frame and the right clamping frame.

A further technical solution is: the housing further includes a slide rail bracket and a fastener for locking the slide rail bracket to the rear case; an upper end of the slide rail bracket is provided with an upper groove, and a lower end of the slide rail bracket is provided with a lower groove; and an upper chute for slidably coupling the right clamping frame is formed between the slide rail bracket and the fastener, and a lower chute for slidably coupling the left clamping frame is formed between the slide rail bracket and the rear case.

A further technical solution is: the electric clamping bracket further includes a circuit board disposed in the housing, and a control device electrically connected to the circuit board; the control device includes an identification module and a touch module; when the identification module detects that a mobile device is approaching the housing, the identification module controls the drive motor to drive the left clamping frame or the right clamping frame so that the left clamping frame and the right clamping frame are close to each other; and when the touch module detects a finger touch, the touch module controls the drive motor to drive the left clamping frame or the right clamping frame so that the left clamping frame and the right clamping frame are far apart opposite to each other; or, the electric clamping bracket further includes a circuit board disposed in the housing, and a control device electrically connected with the circuit board; the control device includes an identification module and a press switch; when the identification module detects that a mobile device is approaching the housing, the identification module controls the drive motor to drive the left clamping frame or the right clamping frame so that the left clamping frame and the right clamping frame are close to each other; and when the press switch is pressed, the press switch controls the drive motor to drive the left clamping frame or the right clamping frame so that the left clamping frame and the right clamping frame are far apart opposite to each other; or, the electric clamping bracket further includes a circuit board disposed in the housing, and a control device electrically connected with the circuit board; the control device includes an identification module, and a pressure switch disposed on the left clamping frame and/or the right clamping frame; and the pressure switch controls the drive motor to drive the left clamping frame or right clamping frame so that the left clamping frame and right clamping frame are far apart opposite to each other.

A further technical solution is: the identification module is a photoelectric sensor module or a magnetic induction module, which is disposed on a front side of the housing; or, when the control device includes the identification module and the touch module, the touch module is a resistive touch switch, a capacitive touch switch and a photoelectric sensor switch provided on a periphery of the housing.

A further technical solution is: the electric clamping bracket further includes a power supply assembly for charging/discharging, a charging induction coil for performing wireless charging, and a USB interface provided on the housing and electrically connected to the power supply assembly; the charging induction coil is electrically connected to the power supply assembly; the drive motor is electrically connected with the power supply assembly; and the charging induction coil is disposed in the housing and is located at a front end of the housing.

A control system of an electric clamping bracket includes: a circuit board, a power module, a microprocessor disposed on the circuit board and electrically connected to the power module, an identification module and a drive motor respectively electrically connected with the microprocessor, a touch module/press switch electrically connected to the microprocessor, and a clamp assembly; the microprocessor receives control signals of the identification module and controls a drive motor to drive the clamping assembly far apart opposite to each other; and the microprocessor receives control signals of the touch module/press switch and controls the drive motor to drive the clamping assembly close to each other.

A further technical solution is: the control system of an electric clamping bracket further includes a charging induction coil, a rechargeable battery, and a USB interface electrically connected with the power module.

A further technical solution is: a driving circuit is further provided between the drive motor and the power module.

A control method of an electric clamping bracket, characterized in that it includes the following:

S100. An identification module detects within a set distance in front of a housing whether a mobile device is approaching, and if so, proceed to S200, if not, the identification module continues to detect;

S200. A drive motor drives clamping ends of a clamp assembly far apart opposite to each other;

S300. The clamping ends of the clamping assembly are close to each other so as to clamp the mobile device;

S400. Whether a touch module/press switch has an input signal, if so, proceeds to S500; if not, the touch module continues to detect; and

S500. The drive motor drives the clamping ends of the clamp assembly far apart opposite to each other to release the mobile device.

A further technical solution is: the clamp assembly includes a left clamping frame and a right clamping frame, and its transmission mode with the drive motor adopts either transmission mode I or transmission mode II;

the transmission mode I is: an output shaft of the drive motor is provided with a gear. The left clamping frame and the right clamping frame are respectively provided with a rack drivenly connected with a gear. The drive motor drives the left clamping frame and the right clamping frame to synchronously move towards or away from each other; and the transmission mode II is: an output shaft of the drive motor is provided with a worm. The left clamping frame and the right clamping frame are respectively provided with a left hand nut and a right hand nut. A screw rod having opposite thread on both ends is drivenly connected between the left hand nut and the right hand nut, and the middle portion of the screw rod is provided with a worm gear that is drivenly connected with the worm.

Compared with the prior art, the technical effect of the present application is: an electric clamping bracket using a motor to drive the clamp assembly to clamp or release a mobile device so as to achieve automatic clamping or releasing of the clamping bracket.

Further, an identification module identifies whether a mobile device is placed so to control operation of the motor to achieve the purpose of automatic releasing of the clamp assembly. At the same time, by recognizing human gesture operation with a touch module or a press switch, a user can control the release of the clamp assembly so to remove a mobile phone by merely triggering the touch module or pressing the press switch, which is very convenient.

Furthermore, a charging induction coil is provided in the housing, and when the mobile phone is placed in the clamping bracket, the mobile device can be wirelessly charged.

A control system of an electric clamping bracket using a microprocessor to coordinate an identification module, a touch module/press switch, a drive motor and a power module so as to achieve automatically clamping or releasing a mobile device by the clamping bracket.

A control method of an electric clamping bracket using an identification module to identify whether a mobile device is placed and using a touch module/press switch to determine whether a person is to use the mobile phone, to intelligently identify the needs of the user and to perform related actions.

The present application will be further described below with reference to the accompanying drawings and specific embodiments.

### DESCRIPTION OF THE DRAWINGS

FIG. 1 is a perspective view of an electric clamping bracket of the present application;

FIG. 2 is an exploded view of an electric clamping bracket of the present application;

FIG. 3 is a cross-sectional view of a slide rail bracket of the present application;

FIG. 4 is a first cross-sectional view of an electric clamping bracket of the present application;

FIG. 5 is a second cross-sectional view of an electric clamping bracket of the present application;

FIG. 6 is a third cross-sectional view of an electric clamping bracket of the present application;

FIG. 7 is a circuit block diagram of a control system of an electric clamping bracket of the present application; and

FIG. 8 is a flow chart of a control method of an electric clamping bracket of the present application.

Reference Numerals

| | | | |
|---|---|---|---|
| 10 | Clamping bracket | 1 | Housing |
| 11 | Front cover | 12 | Rear case |
| 121 | Left mounting slot | 122 | Right mounting slot |
| 14 | Slide rail bracket | 15 | Fastener |
| 16 | IR Lens | 17 | Silicone Mat |
| 2 | Clamp assembly | 21 | Left clamping frame |
| 211 | Left rack | 212 | Right rack |
| 22 | Right clamping frame | 3 | Drive motor |
| 31 | Gear | 4 | Circuit board |
| 5 | Power supply assembly | 6 | Charging induction coil |
| 71 | Left elastic member | 72 | Right elastic member |
| 20 | Control System | S1 | Circuit board |
| S2 | Power module | S3 | Microprocessor |
| S4 | Identification module | S5 | Drive motor |

### DETAILED DESCRIPTION

In order to better understand the technical content of the present application, the technical solutions of the present application are further described and illustrated below in combination with the schematic diagrams, but not limited thereto.

An electric clamping bracket for clamping mobile devices such as mobile phones and tablet computers. The electric clamping bracket includes a housing and a clamp assembly. The electric clamping bracket further includes a drive motor, and the clamp assembly includes a left clamping frame and a right clamping frame. The left clamping frame and the right clamping frame extend forward and are respectively disposed on two opposite sides of the housing, and the left clamping frame or/and the right clamping frame are slidably connected to the housing. The drive motor drives the left clamping frame and/or right clamping frame so that the left clamping frame and the right clamping frame are close to each other or far apart opposite to each other.

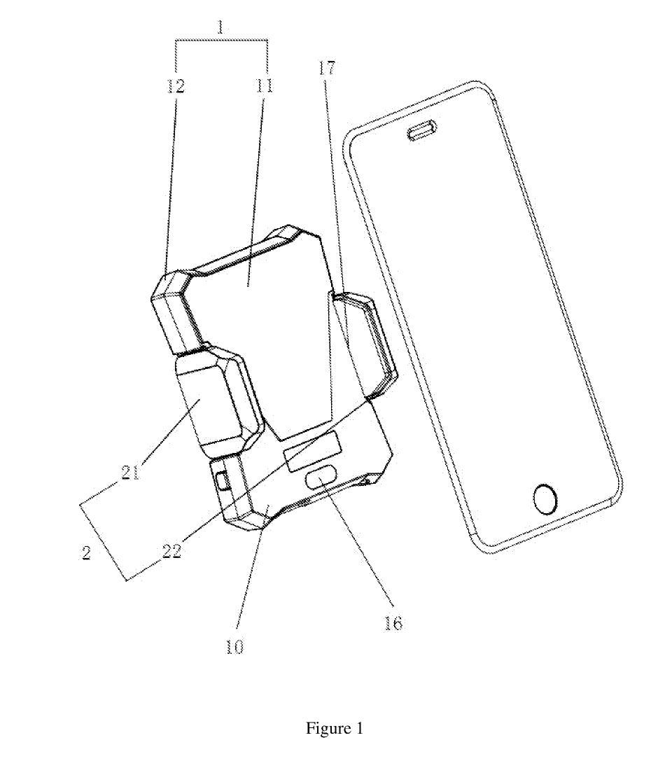

As shown in FIG. 1, an electric clamping bracket 10 is used to clamp mobile devices such as mobile phones and tablet computers. The electric clamping bracket 10 includes a housing 1 and a clamp assembly 2. The housing 1 includes a front cover 11, a rear case 12, and an IR lens 16 fixed on the front cover 11. The housing 1 is provided with a light transmitting hole. When the clamping bracket 10 clamps a mobile phone, it in turn improves shooting quality.

The clamp assembly 2 includes a left clamping frame 21 and a right clamping frame 22. The left clamping frame 21 and the right clamping frame 22 extend forward and are respectively disposed on two opposite sides of the housing 1, and the left clamping frame 21 and the right clamping frame 22 are slidably connected to the housing 1. Two sides of the clamp assembly 2 used for clamping the mobile device are provided with a silicone pad 17. When clamping a mobile phone, the silicone pad 17 can reduce surface damage caused by excessive clamping force of the clamp assembly 2.

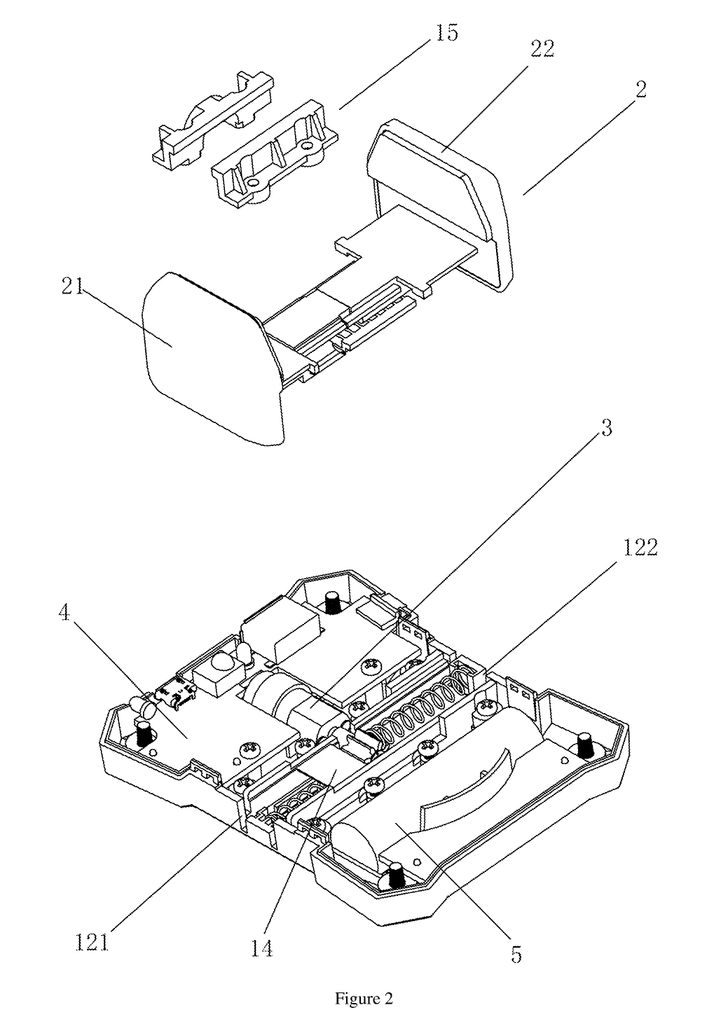

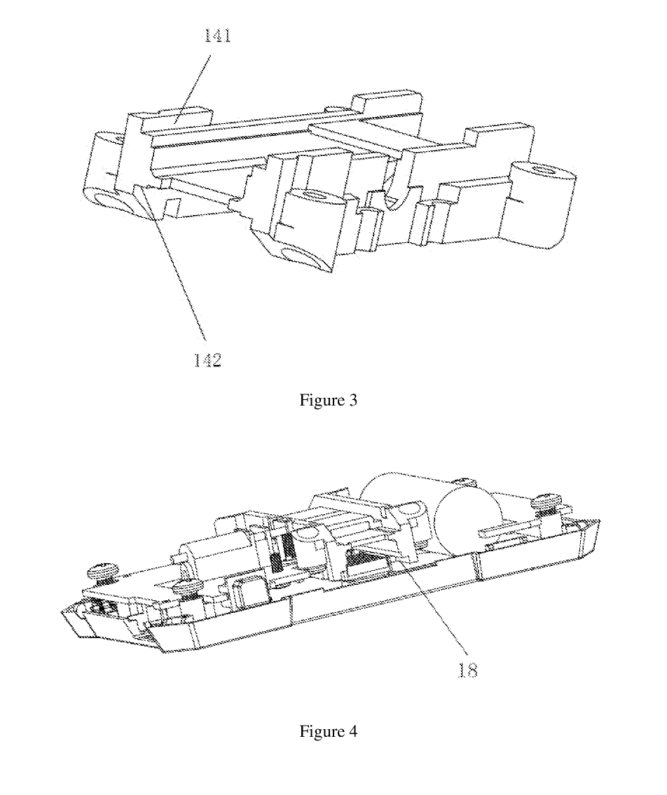

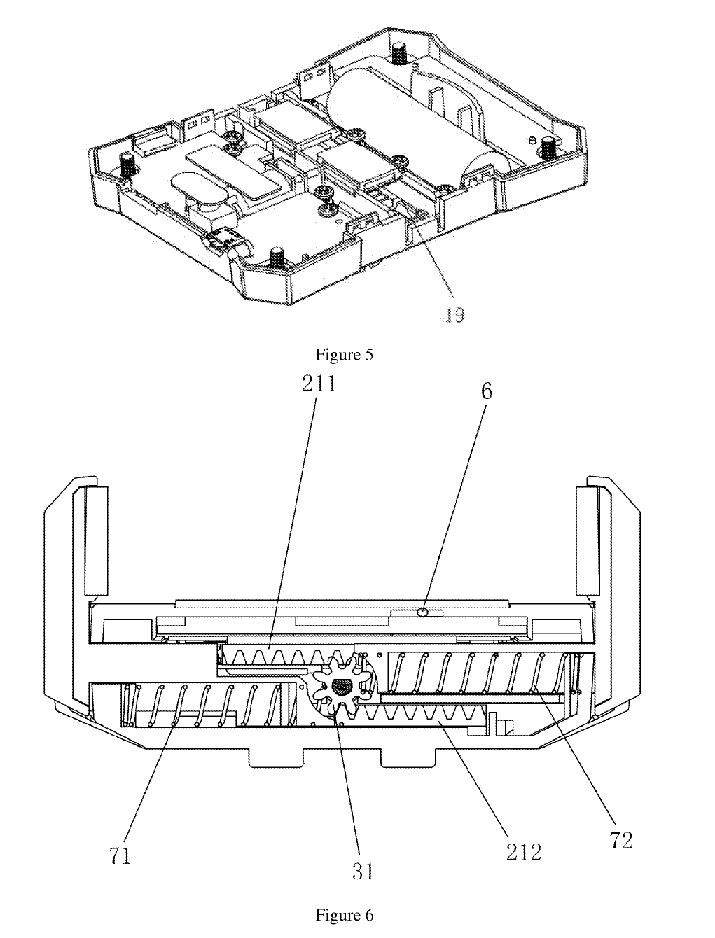

As shown in FIGS. 2-5, the electric clamping bracket 10 further includes a drive motor 3. The drive motor 3 drives the left clamping frame 21 and the right clamping frame 22 so that the left clamping frame 21 and the right clamping frame 22 are close to each other or far apart opposite to each other.

The left clamping frame 21 and the right clamping frame 22 are respectively and fixedly connected with a horizontally disposed left rack 211 and a horizontally disposed right rack 212. The output end of the drive motor 3 is provided with a gear 31 that is drivenly connected between the left rack 211 and the right rack 212. A control device controls the drive motor 3 to drive the left clamping frame 21 and the right clamping frame 22 to synchronously move towards or away from each other.

Both sides of the rear case 12 are respectively provided with a left mounting slot 121 and a right mounting slot 122 for passing through the left clamping frame 21 and the right clamping frame 22.

The housing 1 further includes a slide rail bracket 14 and a fastener 15 for locking the slide rail bracket 14 to the rear case 12. An upper end of the slide rail bracket 14 is provided with an upper groove 141, and a lower end of the slide rail bracket is provided with a lower groove 142. An upper chute 18 for slidably coupling the right clamping frame 22 is formed between the slide rail bracket 14 and the fastener 15, and a lower chute 19 for slidably coupling the left clamping frame 21 is formed between the slide rail bracket 14 and the rear case 12.

The left clamping frame 21 and the right clamping frame 22 are further respectively provided with limiting protrusions to prevent the left clamping frame 21 and the right clamping frame 22 from sliding out of the left mounting slot 121 and the right mounting slot 122.

The electric clamping bracket 10 further includes a circuit board 4 disposed in the housing 1, and a control device electrically connected to the circuit board 4. The control device includes an identification module and a touch module. When the identification module detects that a mobile device is approaching the housing 1, it controls the drive motor 3 to drive the left clamping frame 21 and the right clamping frame 22 so that the left clamping frame 21 and the right clamping frame 22 are close to each other. When the touch module detects a finger touch, it controls the drive motor 3 to drive the left clamping frame 21 and the right clamping frame 22 so that the left clamping frame 21 and the right clamping frame 22 are far apart opposite to each other.

The identification module is a photoelectric sensor module or a magnetic induction module, which is disposed on a front side of the housing 1. The touch module is a resistive touch switch, a capacitive touch switch or a photoelectric sensor switch provided on a periphery of the housing.

As shown in FIG. 6, the electric clamping bracket 10 further includes a left elastic member 71 and a right elastic member 72. The front end of the left elastic member 71 presses against one end of the left clamping frame 21 near the left rack 211, and the rear end of the left elastic member 71 presses against the inner side of the rear case 12. The front end of the right elastic member 72 presses against one end of the right clamping frame 22 near the right rack 212, and the rear end of the right elastic member 72 presses against the inner side of the rear case 12. Wherein, the left clamping frame 21 and the right clamping frame 22 are respectively provided with a groove for mounting the left elastic member 71 and the right elastic member 72, and the front ends of the left elastic member 71 and the right elastic member 72 press against the inner wall of the grooves. When the motor is powered off, the resilience of the left elastic member 71 and the right elastic member 72 brings the left clamping frame 21 and the right clamping frame 22 close to each other, thereby clamping the mobile device placed on the electric clamping bracket 10. In the present embodiment, the left elastic member 71 and the right elastic member 72 are springs. In other embodiments, elastic members such as rubber bands or metal elastic sheet may further be used. In the present embodiment, a gear-and-rack transmission method is adopted. Therefore, elastic members are preferentially used as the power source of the clamping force. The motor only needs to drive the left clamping frame and the right clamping frame to open while closing of the left clamping frame and the right clamping frame is realized by the elastic members. In other embodiments, if worm gear-and-worm transmission method is adopted, due to the irreversible motion which provides a reverse self-locking function, the motor, due to its forward and reverse rotation, can drive the left clamping frame and right clamping frame to open or close.

The electric clamping bracket 10 further includes a power supply assembly 5 for charging/discharging, a charging induction coil 6 for performing wireless charging, and a USB interface provided on the housing 1 and electrically connected to the power supply assembly 5. The charging induction coil 6 is disposed in the housing and is located at a front end of the housing. Specifically, the charging induction coil 6 is fixed to the front cover and is electrically connected with the power supply assembly 5, and the drive motor 3 is electrically connected with the power supply assembly 5. When a mobile device such as a mobile phone or a tablet computer is put into the clamping bracket 10, the charging induction coil 6 can charge the mobile device. When an external power supply has no power, it can be powered by a built-in battery, wherein the battery can be a rechargeable battery. The rechargeable battery may serve as a portable power supply, making present product a power bank.

In a specific example, one of the left clamping frame and the right clamping frame can be selected to be fixed on the housing, and the other is drivenly connected with the drive motor so as to move under the driving of the drive motor and form a clamping or loosening relationship. Both the left clamping frame and the right clamping frame can further be driven by the drive motor to synchronously move close to each other or away from each other, thus forming a clamping or loosening relationship.

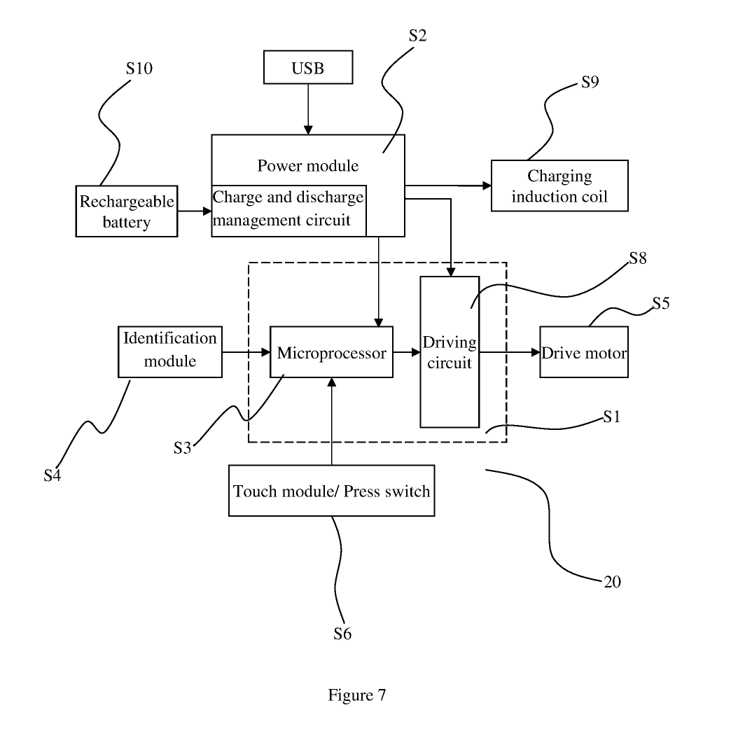

As shown in FIG. 7, a control system 20 of an electric clamping bracket includes: a circuit board 51, a power module S2, a microprocessor S3 disposed on the circuit board 51 and electrically connected to the power module S2, an identification module S4 and a drive motor S5 respectively electrically connected with the microprocessor S3, a touch module/press switch S6 electrically connected to the microprocessor S3, and a clamp assembly. The microprocessor S3 receives control signals of the identification module S4 and controls the drive motor S5 to drive the clamping assembly far apart opposite to each other. The microprocessor S3 receives control signals of the touch module/press switch S6 and controls the drive motor S5 to drive the clamping assembly close to each other. Wherein, the power module S2 is provided with a charge and discharge management circuit, which is electrically connected with a charging interface USB.

Preferably, a driving circuit S8 is further provided between the drive motor S5 and the microprocessor S3. An input end of the driving circuit S8 is electrically connected with the power module S2 and the microprocessor S3, and an output end of the driving circuit S8 is electrically connected with the drive motor S5.

Preferably, the power module S2 is further electrically connected with a charging induction coil S9 and a rechargeable battery S10.

In order to facilitate charging of other products, in addition to an external power supply interface, the housing can further be added with an external charging interface.

In order to increase frictional force and to protect the surface of the mobile device from being damaged, a buffer sheet made of materials such as a silicone sheet or a sponge pad is provided on the inner sides of the left and right clamping frames.

In other embodiments, it is further possible to move only the left clamping frame or the right clamping frame, that is, move one side to achieve clamping or loosening.

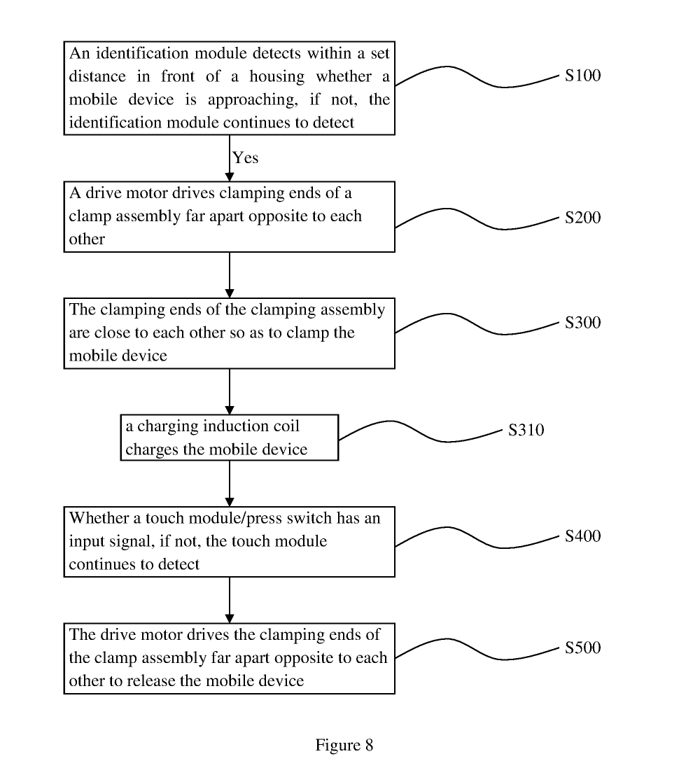

As shown in FIG. 8, a control method of an electric clamping bracket includes the following:

S100. An identification module detects within a set distance in front of a housing whether a mobile device is approaching, and if so, proceed to S200, if not, the identification module continues to detect;

S200. A drive motor drives clamping ends of a clamp assembly far apart opposite to each other;

S300. The clamping ends of the clamping assembly are close to each other so as to clamp the mobile device; wherein clamping of the mobile device by the clamp assembly can be by way of clamping of resilience of a spring, and can further be by way of the drive motor driving a left clamping frame and a right clamping frame to drive clamping;

After clamping the mobile device, step S310 is further included: a charging induction coil charges the mobile device.

S400. Whether a touch module/press switch has an input signal, if so, proceeds to S500; if not, the touch module continues to detect; and

S500. The drive motor drives the clamping ends of the clamp assembly far apart opposite to each other to release the mobile device.

The clamp assembly includes a left clamping frame and a right clamping frame, and its transmission mode with the drive motor adopts either transmission mode I or transmission mode II. Wherein, the transmission mode I is: an output shaft of the drive motor is provided with a gear. The left clamping frame and the right clamping frame are respectively abuttingly connected with a rack drivenly connected with a gear. The drive motor drives the left clamping frame and the right clamping frame to synchronously move towards or away from each other. At the same time, the left clamping frame and the right clamping frame respectively are respectively provided with a left elastic member and a right elastic member. When the motor is not working, the left clamping frame and the right clamping frame, under the action of elastic force, restore to the centre position to achieve the purpose of clamping. The transmission mode II is: an output shaft of the drive motor is provided with a worm. The left clamping frame and the right clamping frame are respectively provided with a left hand nut and a right hand nut. A screw rod having opposite thread on both ends is drivenly connected between the left hand nut and the right hand nut, and the middle portion of the screw rod is provided with a driven wheel. Alternatively, two screw rods having the same thread on both ends are drivenly connected between the left hand nut and the right hand nut. Each inner end of the two screw rods is provided with a conical driven gear arranged opposite to each other. A worm gear drivenly connected with a worm is fixedly connected with a conical main wheel. At this time, the axis of the motor is parallel to the movement direction of the left clamping frame and the right clamping frame. Because the worm gear drivenly connected with a worm is fixedly connected with a main driving wheel, adoption of this structure does not require the use of elastic members for clamping and restoration of position. In other embodiments, gears and the cooperation of screw rods and nuts can be used to achieve simultaneous drive or single drive of the left clamping frame and the right clamping frame. The transmission mode II realizes the two-way motion by the motor. Therefore, the racks need to be fixedly connected with the clamping frames. The transmission mode I realizes the motion of moving outward and opening by the motor and the motion of moving inward and closing by the elastic members. Therefore, the racks and the clamping frames need to be respectively slidably connected to the housing, and the adjacent end portions conflict with each other to achieve the motion transmission in the two directions of outward and inward. Preferably, a tension spring is used.

In other embodiments, the electric clamping bracket further includes a circuit board disposed in the housing, and a control device electrically connected with the circuit board. The control device includes an identification module, and a pressure switch disposed on the inner side of the left clamping frame and/or the right clamping frame. The pressure switch controls the drive motor to drive the left clamping frame or right clamping frame so that the left clamping frame and right clamping frame are far apart opposite to each other. Wherein, the pressure switch needs to be restarted after the mobile device is clamped, or to detect twice or more times of pulse signal in order to recognize them as control signals for picking up the mobile device. Or, by mean of feedback electric signals of the motor, the left clamping frame and the right clamping frame being pushed can be determined thereby recognizing it as a control signal for a user picking up the mobile device, wherein the movement of the left clamping frame and the right clamping frame will reversely drive the motor to rotate, thereby generating an electrical signal. This structure is suitable for the fixed connection between the left rack and the left clamping frame and between the right rack and the right clamping frame.

In other embodiments, the electric clamping bracket further includes a circuit board disposed in the housing, and a control device electrically connected with the circuit board. The control device includes an identification module and a press switch. When the identification module detects that a mobile device is approaching the housing, it controls the drive motor to drive the left clamping frame or the right clamping frame so that the left clamping frame and the right clamping frame are close to each other. When the press switch is pressed, it controls the drive motor to drive the left clamping frame or the right clamping frame so that the left clamping frame and the right clamping frame are far apart opposite to each other.

In other embodiments, the electric clamping bracket further includes a horizontally disposed left rack and a horizontally disposed right rack; the left rack and the right rack are respectively slidably connected to a housing; an output end of the drive motor is provided with a gear that is drivenly connected between the left rack and the right rack; when the drive motor drives the left rack and the right rack to move outward, the left rack and the right rack respectively press against the left clamping frame and the right clamping frame to move synchronously to both sides; the electric clamping bracket further includes a left elastic member and a right elastic member; the front end of the left elastic member presses against one end of the left clamping frame near the left rack, and the rear end of the left elastic member presses against the rear case; the front end of the right elastic member presses against one end of the right clamping frame near the right rack, and the rear end of the right elastic member presses against the rear case; when the drive motor forwardly drives the left rack and the right rack to move outward, the left rack and the right rack respectively press against inner ends of the left clamping frame and the right clamping frame so to synchronously move the two outward and apart; when the drive motor reversely drives the left rack and the right rack to move outward, the left clamping frame and the right clamping frame under the respective action of the elastic tension of the left elastic member and the right elastic member move inward and close together.

The foregoing merely describes the technical content of the present application by way of example only, so as to facilitate the reader's understanding, but it does not mean that the embodiment of the present application is limited thereto. Any technical extension or re-creation according to the present application is subject to the protection of the present application. The protection scope of the present application is subject to the claims.

What is claimed is:

1. An electric clamping bracket comprising a housing and a clamp assembly, wherein the electric clamping bracket further comprises a drive motor; the clamp assembly comprises a left clamping frame and a right clamping frame; the left clamping frame and the right clamping frame extend forward and are respectively disposed on two opposite sides of the housing; the left clamping frame or/and the right clamping frame are slidably connected to the housing; and the drive motor drives the left clamping frame and/or right clamping frame so that the left clamping frame and the right clamping frame are close to each other or far apart opposite to each other.

2. The electric clamping bracket of claim 1, wherein the left clamping frame and the right clamping frame are respectively provided with a horizontally disposed left rack and a horizontally disposed right rack; an output end of the drive motor is provided with a gear that is drivenly connected between the left rack and the right rack; and the drive motor drives the left clamping frame and the right clamping frame to synchronously move towards or away from each other;
or, the electric clamping bracket further comprises a horizontally disposed left rack and a horizontally disposed right rack; the left rack and the right rack are respectively slidably connected to the housing; an output end of the drive motor is provided with a gear that is drivenly connected between the left rack and the right rack; the electric clamping bracket further comprises a left elastic member and a right elastic member; a front end of the left elastic member presses against one end of the left clamping frame near the left rack, and a rear end of the left elastic member presses against a rear case of the housing; a front end of the right elastic member presses against one end of the right clamping frame near the right rack, and a rear end of the right elastic member presses against the rear case; when the drive motor forwardly drives the left rack and the right rack to move outward, the left rack and the right rack respectively press against inner ends of the left clamping frame and the right clamping frame so to synchronously move the left clamping frame and the right clamping frame outward and apart; and when the drive motor reversely drives the left rack and the right rack to move outward, the left clamping frame and the right clamping frame under respective action of an elastic tension of the left elastic member and the right elastic member move inward and close together.

3. The electric clamping bracket of claim 1, wherein the housing comprises a front cover and a rear case; and both sides of the rear case are respectively provided with a left mounting slot and a right mounting slot for passing through the left clamping frame and the right clamping frame.

4. The electric clamping bracket of claim 3, wherein the housing further comprises a slide rail bracket and a fastener for locking the slide rail bracket to the rear case; an upper end of the slide rail bracket is provided with an upper groove, and a lower end of the slide rail bracket is provided with a lower groove; and an upper chute for slidably coupling the right clamping frame is formed between the slide rail bracket and the fastener, and a lower chute for slidably coupling the left clamping frame is formed between the slide rail bracket and the rear case.

5. The electric clamping bracket of claim 1, wherein the electric clamping bracket further comprises a circuit board disposed in the housing, and a control device electrically connected to the circuit board; the control device comprises an identification module and a touch module; when the identification module detects that a mobile device is approaching the housing, the identification module controls the drive motor to drive the left clamping frame or the right clamping frame so that the left clamping frame and the right clamping frame are close to each other; and when the touch module detects a finger touch, the touch module controls the drive motor to drive the left clamping frame or the right clamping frame so that the left clamping frame and the right clamping frame are far apart opposite to each other;
or, the electric clamping bracket further comprises a circuit board disposed in the housing, and a control device electrically connected with the circuit board; the control device comprises an identification module and a press switch; when the identification module detects that a mobile device is approaching the housing, the identification module controls the drive motor to drive the left clamping frame or the right clamping frame so that the left clamping frame and the right clamping frame are close to each other; and when the press switch is pressed, the press switch controls the drive motor to drive the left clamping frame or the right clamping frame so that the left clamping frame and the right clamping frame are far apart opposite to each other;
or, the electric clamping bracket further comprises a circuit board disposed in the housing, and a control device electrically connected with the circuit board; the control device comprises an identification module, and a pressure switch disposed on the left clamping frame and/or the right clamping frame; and the pressure switch controls the drive motor to drive the left clamping frame or right clamping frame so that the left clamping frame and right clamping frame are far apart opposite to each other.

6. The electric clamping bracket of claim 5, wherein the identification module is a photoelectric sensor module or a magnetic induction module, which is disposed on a front side of the housing;
or, when the control device comprises the identification module and the touch module, the touch module is a resistive touch switch, a capacitive touch switch and a photoelectric sensor switch provided on a periphery of the housing.

7. The electric clamping bracket of claim 1, wherein the electric clamping bracket further comprises a power supply assembly for charging/discharging, a charging induction coil for performing wireless charging, and a USB interface provided on the housing and electrically connected to the power supply assembly; the charging induction coil is electrically connected to the power supply assembly; the drive motor is electrically connected with the power supply assembly; and the charging induction coil is disposed in the housing and is located at a front end of the housing.

8. A control system of an electric clamping bracket, comprising a circuit board, a power module, a microprocessor disposed on the circuit board and electrically connected to the power module, an identification module and a drive motor respectively electrically connected with the microprocessor, a touch module/press switch electrically connected to the microprocessor, and a clamp assembly; the microprocessor receives control signals of the identification module and controls a drive motor to drive the clamping assembly far apart opposite to each other; and the microprocessor receives control signals of the touch module/press switch and controls the drive motor to drive the clamping assembly close to each other.

9. The control system of claim 8, further comprising a charging induction coil, a rechargeable battery, and a USB interface electrically connected with the power module.

10. The control system of claim 8, wherein a driving circuit is further provided between the drive motor and the power module.
